(19) United States
(12) Patent Application Publication
(10) Pub. No.: US 2009/0079234 A1
(43) Pub. Date: Mar. 26, 2009

(54) Adjustment Device for a Sliding Roof Cover on a Vehicle

(75) Inventor: Manfred Faerber, Wielenbach (DE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Webasto AG, Stockdorf (DE)

(21) Appl. No.: 12/162,387

(22) PCT Filed: Feb. 27, 2007
(86) PCT No.: PCT/DE2007/000366

§ 371 Date: Jul. 28, 2008

(30) Foreign Application Priority Data
Mar. 8, 2006 (DE) 10 2006 010 755.1

(51) Int. Cl. B60J 7/04

(52) U.S. Cl. 296/216.05

(57) ABSTRACT

A adjustment device for a sliding roof cover on a vehicle, comprising a guide rail, which runs in a longitudinal direction, for guiding sliders which are arranged in series in the longitudinal direction and control the movement of the sliding roof cover, wherein the first slider can be moved along the guide rail by means of a drive device and, over a part of its movement range, drives the second slider, and over another part of its movement range, leaves the second slider behind in a predefined position along the guide rail, wherein a locking element, which can be adjusted in height in a manner controlled by the first slider, is arranged on the second slider, which locking element, when the second slider is left behind, is placed by means of a height adjustment into a form-fitting connection with a guide rail section in order to lock the second slider to the guide rail. Here, in order to avoid unfavourable forces during the locking and release of the second slider, it is proposed according to the invention that a rotary bar, which can be rotated about a vertical axis in a manner controlled by the first slider, is also arranged on the second slider, which rotary bar, when the second slider is left behind, is rotated into a rotational position which secures the locking action after the height adjustment of the locking element.

The present invention relates to an adjustment device for a sliding roof cover on a vehicle according to the precharacterizing clause of claim 1.

An adjustment device of this type is known, for example, from DE 100 09 387 C1.

In the case of the known device, the sliding roof cover can be deployed to the outside about a front pivot axis from a closed position and can then be moved to the rear in order to open up a roof opening. A respective cover holder is arranged on both sides of the cover, on the lower side thereof, said cover holder being coupled to two sliders which are arranged consecutively in the longitudinal direction of the vehicle, control the movement of the cover and are guided in a guide rail which runs in the longitudinal direction of the vehicle and is mounted on the vehicle. A first of the two sliders can be moved as a drivable carriage along the guide rail and, over part of its movement range, carries along a second slider, which is formed by a sliding pin and a control lever, whereas the first slider, over a different part of its movement range, leaves behind the second slider in a predetermined position along the guide rail. The control lever of the second slider is pivoted in a controlled manner by means of a slotted guide coupling between the two sliders such that, when the second slider is left behind, a locking pin arranged on the control lever is brought by means of a height adjustment into a guide rail cutout in order to arrest the second slider on the guide rail.

The arresting action of the second slider is ensured by the slotted guide coupling being maintained over the corresponding part of the movement range of the first slider.

This method of locking the arresting action has the disadvantage that, when the second slider is left behind, a slotted guide coupling has to be maintained between the two sliders, which in particular signifies an increased structural outlay if, after the second slider is arrested, a comparatively large adjustment travel of the first slider is desired. Irrespective thereof, this manner of locking the arresting action is associated with unfavorable force moments which may have a disadvantageous effect on, for example, the smooth running of the slider movement.

Similar adjustment devices are known, for example, from DE 37 15 268 A1 and DE 100 39 150 C1.

Also in the case of these known devices, one of two sliders running in a guide rail is arrested in a manner controlled by the other slider, for which purpose an arresting element is pivoted into a guide rail cutout and, for unlocking purposes, is pivoted out of it again. In the first-mentioned publication, the arresting element is preloaded in the locking direction by means of a spring and, in the second-mentioned publication, is preloaded in the unlocking direction by means of a spring.

Although the locking operation or the unlocking operation can be simplified by such preloading actions or the arresting or release of the second slider can be ensured by such a preloading action (by means of the spring force), structural solutions of this type, in particular due to fatigue phenomena, generally do not withstand any relatively long operating periods and malfunctions may occur. The latter problem could indeed be countered by the provision of a spring of correspondingly large dimensions. However, this inevitably leads in turn to relatively large actuating forces during the operation of the device, which in turn involves an increased structural outlay with regard to the mechanical stability of the device components.

In summary, the known mechanisms for arresting and releasing the slider in question and for securing (locking) and reversing (unlocking) the arresting action have to absorb unfavorable forces or transmit forces to other components of the adjustment device in a manner which may have a disadvantageous effect on the slider movements.

It is therefore an object of the present invention to provide an adjustment device of the type mentioned at the beginning in which unfavorable forces in conjunction with the arresting action and release of the second slider can be avoided.

This object is achieved by an adjustment device with the features of claim 1. The dependent claims relate to advantageous developments of the invention.

In the case of the adjustment device according to the invention, a rotary latch which can be rotated about a vertical axis in a manner controlled by the first slider is arranged on the second slider and, when the second slider is left behind, and after the height adjustment of the arresting element, is rotated into a rotary position locking the arresting action.

This provides a simple and functionally reliable locking (and release) of the arresting action. The functional reliability of the solution according to the invention is based on the fact that an application of force, caused for example by means of vibrations or impacts, to the arresting element in the vertical direction can be reliably absorbed by the rotary latch (in order to avoid a movement of the arresting element) and, furthermore, at most loads the rotary latch parallel to its axis of rotation, but does not exert a rotating force moment on the rotary latch.

Furthermore, the rotary latch can be provided such that it can be readily actuated (pivoted) in the locking rotary direction and/or unlocking rotary direction without significant application of force (for example by means of frictional forces).

Forces which are introduced in known devices directly from the arresting mechanism to the locking mechanism and are therefore unfavorable can be advantageously avoided in the case of the invention. In the case of the invention, the forces acting during the securing of the arresting action and release can to a certain extent be “decoupled” from the forces acting during the actuation of the rotary latch. The counterforces required to secure the arresting action can advantageously be absorbed by means of the rotary latch which is rotated in its locking rotary position. They are therefore kept away from the remaining components of the adjustment device.

A preferred use of the invention is the adjustment of a sliding roof cover which, in a closed position, closes a roof opening, can be pivoted up into a deployment position (“ventilation position”) and can then be pushed back. This is, for example, the case with “spoiler roofs” or sliding roofs which run on the outside. However, the adjustment device is equally suitable, for example, for sliding roofs in which, as an alternative or in addition to being pivoted upwards, the cover can be lowered from the closed position and then pushed back. In this context, the only essential concern of the invention is that two sliders, which can be moved along a guide rail, are provided for controlling the sliding roof cover movement (which can be configured in any desired manner per se) and a coupling between the sliders for them to be carried along exists only over part of the movement range of one of the two sliders (“first slider”).

The longitudinal direction in which the guide rail mounted on the vehicle extends is the “sliding direction” of the sliding roof cover. This longitudinal direction is usually identical to the longitudinal direction of the vehicle concerned.

At least one of the two sliders can be connected at least indirectly, in a manner known per se, to the sliding roof cover or a cover carrier carrying the cover. The cover or cover carrier can be connected to the sliders, for example, by means of deployment levers, lifting slots, etc.

The drive device moving the first slider along the guide rail can comprise in a manner known per se, for example, a pressure-resistant drive cable which is connected to the first slider for carrying it along and is guided, running in the longitudinal direction, on or in the guide rail.

In a preferred embodiment, the rotary latch has a radially protruding latching cam which, for locking purposes, pivots into a clearance, which is created by the height adjustment, between a section of the second slider, which section is connected to the locking element, and a section of the guide rail. Said clearance or the latching cam pivoting into it there is preferably dimensioned in this case in such a manner that the pivoting essentially takes place without significant application of force (for example by means of frictional forces). The same is true of the pivoting of the latching cam out of the clearance in the event of the unlocking of the arresting action. The latching cam is preferably bounded in the axial direction (vertical direction) by two latching cam surfaces which extend essentially orthogonally to the axial direction and against which, in the locked state, the relevant section of the second slider and the relevant section of the guide rail (preferably likewise with horizontal stop surfaces) bear.

For a structurally simple activation of the rotation of the rotary latch, it is advantageous if the rotary latch has two control cams which protrude radially, are offset in angle with respect to each other and with which a laterally protruding control bolt of the first slider interacts in order to rotate the rotary latch. For a compact constructional form, it is again advantageous here if the two control cams are arranged on the rotary latch at the same height axially. If, in this case, the abovementioned locking cam is provided, then it is preferably arranged offset axially with respect to the two control cams on the rotary latch.

In a preferred embodiment, the rotary latch is manufactured as a molded plastic part (for example injection molded part). This is unproblematic insofar as said component does not have to be significantly loaded during the actuation (rotation) thereof and the “locking force” only subjects the rotary latch to an axial pressure.

In the case of the adjustment device according to the invention, the abovementioned control bolt of the first slider can have further functions in addition to the actuation of the rotary latch. It is thus provided according to one development that the control bolt of the first slider interacts with a slotted guide track of a section of the second slider, which section is connected to the arresting element, in order to bring about the height adjustment. If a stop for the control bolt is provided at least one end of a slotted guide track of this type, then the control bolt can furthermore use said stop to bring about the coupling between the two sliders for carrying them along.

In one embodiment of the invention, it is provided that the rotary latch is secured in its locking rotary position and/or in its unlocking rotary position by means of spring loading. It is worth mentioning in this connection that such a spring loading, in contrast to the spring loadings mentioned at the beginning with regard to the prior art, can advantageously be dimensioned to be extremely small, since it is possible for all the forces acting on the rotary latch during operation with the effect of rotating the same to be very small.

In one embodiment, it is provided that, after the second slider is left behind, the first slider is completely decoupled from the second slider. If the first slider is coupled to the second slider, for example via a slotted guide coupling, then a complete decoupling can be provided by the relevant slotted guide track being “open” at one end such that decoupling can take place at this point and the first slider, when the second slider is left behind, can in principle be moved any desired distance.

In an advantageous embodiment, it is provided that the first slider runs with a laterally protruding control bolt in a slotted guide track which is open on one side (for example slotted guide slot) and is provided on the second slider, in particular on a section of the second slider that is connected to the height-adjustable arresting element.

In one embodiment, the arresting element is arranged on an arresting lever, which can be pivoted about a transverse axis, of the second slider. The height adjustment of the arresting element can then be brought about by pivoting the arresting lever, with the arrangement of the arresting element in the region of the free end of the arresting lever being preferred for a large height adjustment at a predetermined pivoting angle.

In a preferred embodiment, it is provided that the arresting element protrudes laterally from the second slider and, during the carrying-along of the second slider, runs in a guide channel of the guide rail, which guide channel is bounded by a horizontal guide rail web, and, when the predetermined position is reached, penetrates by means of the height adjustment into a cutout of the guide rail web.

The invention is explained in more detail below using an exemplary embodiment and with reference to the attached drawings, in which:

FIG. 1 shows a side view of an adjustment device for a sliding roof cover, wherein the situation for the closed position of the cover is illustrated,

FIG. 2 shows a side view similar to FIG. 1, but for a first intermediate position (in the course of a roof opening operation),

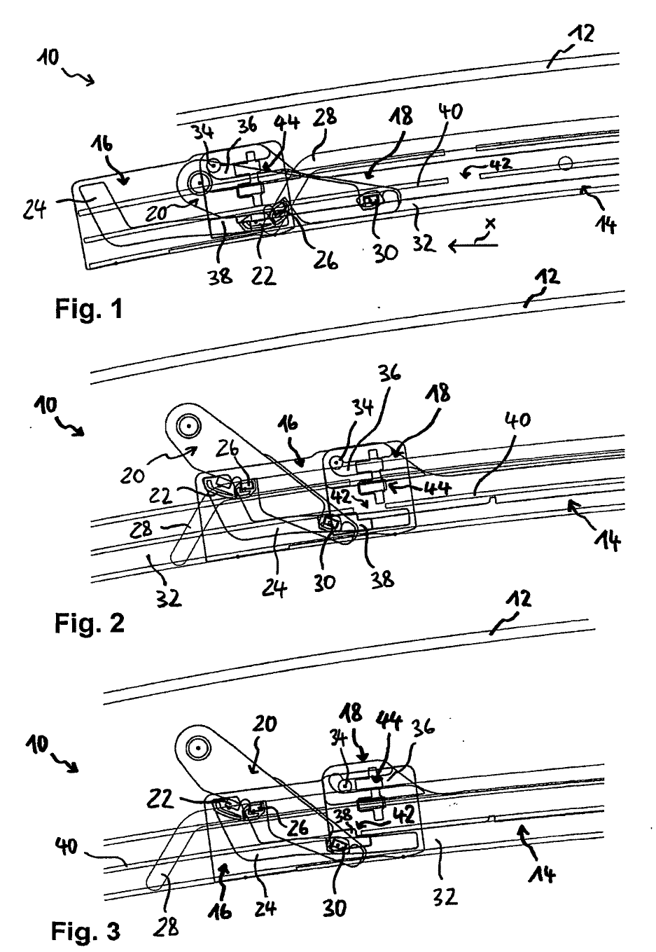

FIG. 3 shows a side view similar to FIG. 1 but for a second intermediate position,

FIG. 4 shows a perspective view of the situation according to FIG. 3,

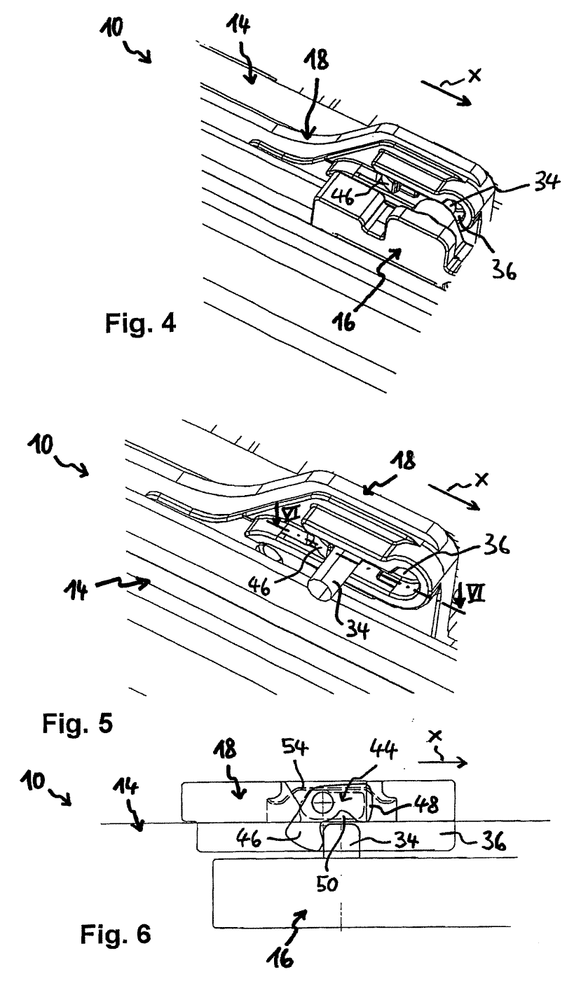

FIG. 5 shows a perspective view similar to FIG. 4 but for a third intermediate position,

FIG. 6 shows a horizontal sectional view along the line VI-VI in FIG. 5,

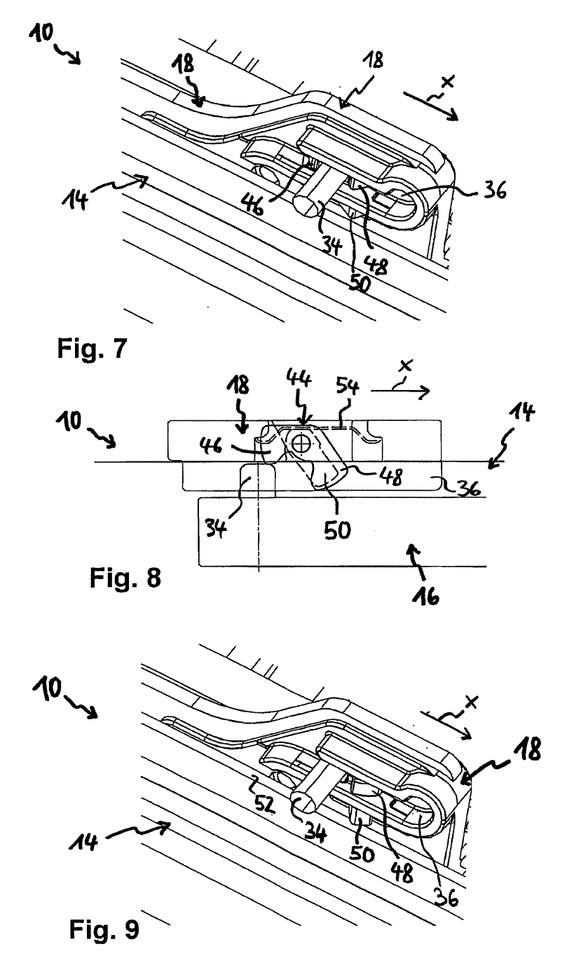

FIG. 7 shows a perspective view similar to FIG. 5 but for a fourth intermediate position,

FIG. 8 shows a sectional view corresponding to FIG. 6 but for a fifth intermediate position,

FIG. 9 shows a perspective view similar to FIG. 5 but for the fifth intermediate position,

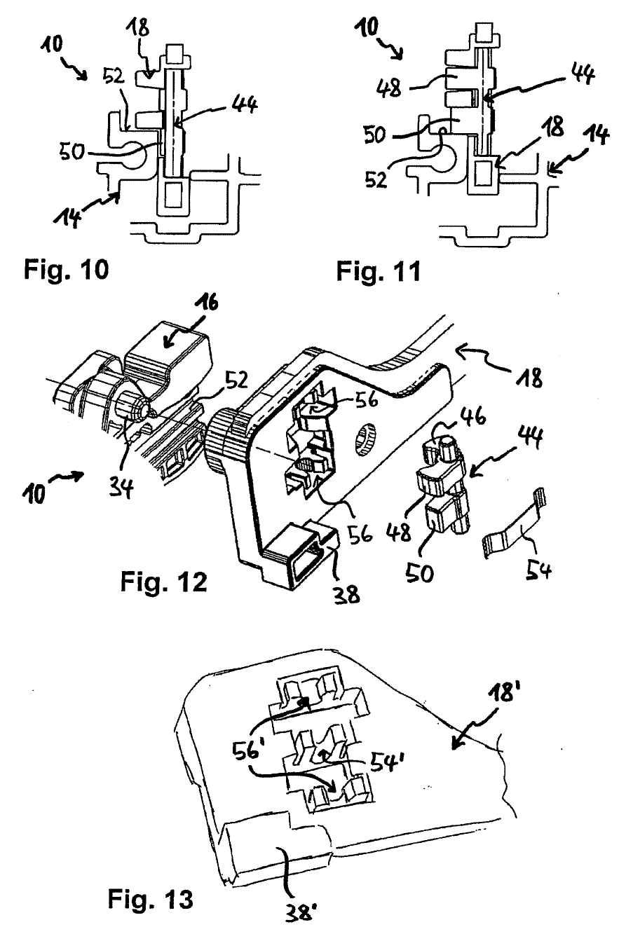

FIG. 10 shows a cross-sectional view to illustrate the unlocked state of the slider arresting action, as is present, for example, in the situations according to FIGS. 1 to 6,

FIG. 11 shows a cross-sectional view similar to FIG. 10, but for the locked state of the slider arresting action, as is present, for example, for the situations according to FIGS. 8 and 9,

FIG. 12 shows an exploded illustration of some of the device components which are essential for the locking mechanism, and

FIG. 13 shows a perspective illustration for illustrating a modification of the mechanism shown in FIG. 12.

FIG. 1 shows a front region of an adjustment device, denoted overall by 10, for a sliding roof cover 12 on a motor vehicle. The sliding direction of the cover 12, at the same time the longitudinal direction of the vehicle, is indicated in the Figure by an arrow x.

For the sake of keeping the illustration simple, only device components arranged on one side of the cover 12, which device components are actually present in a manner known per se on both sides of the cover, are illustrated and described below.

The adjustment device 10 comprises (on each side of the cover) a guide rail 14 which runs in the longitudinal direction x, is mounted on the vehicle and is intended for guiding a (front) first slider 16 and a (rear) second slider 18.

The sliders 16, 18 serve to control all of the movements of the sliding roof cover 12 which, in the situation illustrated in FIG. 1, closes a roof cutout (roof opening), not illustrated, of the motor vehicle roof. In this closed position, the cover 12 is arranged approximately flush with the vehicle roof contour (not illustrated).

Starting from the closed position, the cover 12 can first of all be raised (ventilation position) and then displaced to the rear (to the right in FIG. 1) over a fixed roof skin section. For this purpose, the cover 12 is joined on both sides via two deployment levers which are each articulated on the vehicle in the region of the guide rail 14. The front of these two deployment levers can be seen in FIG. 1 and is referred to by 20. A second deployment lever arranged further to the rear (further to the right in FIG. 1) cannot be seen in the region illustrated in FIG. 1.

The first slider 16 is designed as a sliding carriage which can be moved in a manner known per se in direction x along the guide rail 14 by means of a pressure-resistant drive cable which acts on it and runs in a channel of the guide rail 14.

If said first slider 16 is moved to the rear from its front end position, illustrated in FIG. 1, by means of the drive cable, then this brings about a deployment of the deployment lever 20 which is articulated at its front end on a cover carrier (not illustrated) such that the cover 12 is raised upward in the region illustrated.

This state is illustrated as a first intermediate position in FIG. 2.

The manner in which the deployment movement of the cover 12 is brought about is not the subject matter of the present invention and it could therefore also be provided in any other suitable manner.

In the exemplary embodiment illustrated, the deployment of the deployment lever 20 as a result of the movement of the first slider 16 is brought about in such a manner that three sliding pieces protruding laterally from the deployment lever 20 run in three different guide tracks. A front sliding piece 22 of the lever 20 runs in a slotted guide 24 of the first slider 16, a central sliding piece 26 of the lever 20 runs in a slotted guide 28 of the guide rail 14, and a rear sliding piece 30 of the lever 20 runs in a guide channel 32 of the guide rail 14.

FIG. 3 shows a second intermediate position of the movement of the slider 16 to the rear.

The first slider 16 (drive carriage) inevitably carries along the second slider 18 with it to the rear over that part of its movement range which is illustrated in FIGS. 1 to 3.

The carry-along coupling required for this purpose is brought about by the engagement of a control bolt 34, which protrudes laterally on the first slider 16, in an obliquely running section of a control slot 36 which is formed on the second slider 18.

During the movement of the first slider and therefore of the control bolt 34, the control bolt 34 presses the slotted guide 36 and therefore the second slider 18 to the rear synchronously with the movement of the first slider 16. In a first part of this movement sequence (cf. FIGS. 1 and 2), the control bolt 34 here cannot be moved relative to the guide slot 36 (obliquely downward), since, in this movement phase, the slotted guide region 36 of the second slider 18 is fixed in its height with respect to the guide rail 14. This fixing is realized by means of a latching contour (arresting element) which is referred to in the Figures by 38, protrudes laterally from the second slider 18 and runs in the guide channel 32 of the guide rail 14. The guide channel 32 is bounded upward by means of a guide rail web 40 (one of a plurality of such webs of the guide rail). Only when the sliders 16, 18 which are coupled for carrying-along purposes have reached the position illustrated in FIG. 3 can the control bolt 34 move in the control slot 36, since, in this position, the latching contour 38 latches upward into a cutout 42 of the guide rail 14. That part of the second slider 18 which can be seen in FIGS. 1 to 3 is designed as a pivotable “latching lever” (with the latching contour 38 at its free end), the pivoting axis not being illustrated in the Figures and running in the transverse direction approximately at the right edge of FIG. 1. A corresponding pivot bearing of the second slider 18 is guided by the guide rail 14 in a manner such that it can be displaced in direction x.

Although, during the transition from FIG. 2 to FIG. 3, in precise terms a pivoting movement (with slight translation) of the second slider 18 takes place, said movement, depending on the distance of the pivot bearing, can be approximately considered to be a height adjustment.

With the reaching of the intermediate position illustrated in FIG. 3, first of all the coupling of the two sliders 16, 18 for carrying them along is ended (since the control bolt 34 enters a longitudinally running section of the control slot 36) and secondly the second slider 18 is arrested in its position along the guide rail (by means of the engagement of the latching contour 38 in the guide rail cutout 42).

Upon the further movement of the first slider 16 to the rear, the second slider 18 is then left behind in its position predetermined by the cutout 42. This part of the movement range of the first slider 16 is provided for the displacement of the sliding roof cover 12 to the rear over the fixed roof skin. As long as, during this further movement, the control bolt 34 is still in engagement with the control slot 36 of the second slider 18, the position in terms of height of the illustrated section of the slider 18 and therefore the arresting action of the slider 18 are ensured.

Since, however, upon the further movement the control bolt 34 leaves the control slot 36, which is relatively short in the direction x, in the case of this adjustment device 10 it is ensured that the second slider 18 is fixed in terms of height and therefore the slider 18 is arrested by means of a special locking mechanism directly before said leaving action takes place.

The locking mechanism is essentially formed by a rotary latch 44 which is mounted on the second slider 18 and can be rotated about a vertical axis. It is essential in this case that, when the second slider 18 is left behind and after the height adjustment of the illustrated section of the second slider 18, the rotary latch 44 is rotated into a rotary position locking the arresting action. In the exemplary embodiment illustrated, this rotation is realized by means of action of the control bolt 34 on one of two control cams 46, 48 protruding radially from the rotary latch 44.

This mechanism provided for the locking (and unlocking) can be better seen in the figures described below.

FIG. 4 is a perspective view (from the inside) in which it is clear how the control bolt 34 of the driven slider 16 engages in the control slot 36 of the second slider 18. The situation illustrated in FIG. 4 corresponds to the situation illustrated in FIG. 3 (second intermediate position).

Furthermore, a first control cam 46 of the two control cams 46, 48, which control cam projects laterally into the control slot 36 in the situation illustrated, can be seen in FIG. 4.

FIGS. 5 and 6 respectively show, perspectively and in a section, a third intermediate position in the sequence of movement, in which the control bolt 34 runs against the first control cam 46. For the sake of clarity of the illustration, of the first slider 16 only the control bolt 34 is shown in FIG. 5.

During the further sequence of movement, the control cam 46 now yields to the control bolt 34 running against it such that the rotary latch 44 is rotated (in the clockwise direction in FIG. 6).

There is a fourth intermediate position which is shown in FIG. 7. The second control cam 48 which pivots at this stage into the space of the control slot 36 can also already be seen in this Figure.

When the fifth intermediate position shown in FIG. 8 is reached, the locking operation is finished. In the exemplary embodiment illustrated, the rotary latch 44 has been rotated for this purpose through approximately 50°.

As is apparent from FIGS. 6 to 9, the rotary latch 44 furthermore has a radially protruding latching cam 50 which, offset in the axial direction with respect to the control cam arrangement 44, 46 and as viewed in the circumferential direction, is provided approximately in the angular position of the second control cam 48.

In FIG. 9, the latching cam 50 is located in a region, as viewed in the vertical direction, between a surface 52 of the guide rail 14 and a section of the second slider 18, which section bounds the control slot 36, such that the height adjustment of the second slider 18, which height adjustment is apparent in FIG. 9 and is activated by the control bolt 34, is continuing to be ensured even if, during the further sequence of movement, the control bolt 34 leaves the control slot 36 (to the left in FIG. 9). A simple and reliable locking of the second slider 18 in the arrested state is therefore realized with the pivoted latching cam 50.

It is notable here that, firstly, the rotation of the rotary latch 44 that is necessary for locking purposes can be brought about by means of the control bolt 34 without significant effort and that every force which occurs during operation, in particular while the relevant vehicle is underway, and which attempts to press the second slider 18 downward is reliably absorbed by the latching cam 50 which, in turn, is supported on the guide rail 14. Furthermore, such forces are advantageously kept away from the remaining components of the adjustment device 10.

FIGS. 10 and 11 respectively once again illustrate, in a cross-sectional view, the unlocked state (FIG. 10) and the locked state (FIG. 11). It is apparent therefrom that the latching cam 50, for locking purposes, is pivoted into an axial clearance between the guide rail 14 and the second slider 18, which clearance has been created only by the preceding height adjustment of the second slider 18 (upward in FIGS. 10 and 11).

The above-described sequence of movement takes place in the reverse sequence for the closing of the sliding roof cover 12.

As far as the unlocking operation which takes place in this reverse sequence of movement is concerned, it is apparent, for example from FIG. 8, that, during said movement, the second control cam 48 which, in the locked state, protrudes into the control slot 36, is displaced by the control bolt 34 such that the rotary latch 44 is rotated back into its initial rotary position (cf. FIG. 6).

FIG. 12 shows once again, in an exploded illustration, some of the device components which have already been described above. A leaf spring 54 is also illustrated here, said leaf spring, in the fitted state, ensuring a latching connection of the rotary latch 44 at a snap-in receptacle 56 of the second slider 18 and securing the rotary latch 44 both in its locking rotary position and its unlocking rotary position. The latter rotational securing is not required per se, but particularly reliably ensures that, after actuation by the control bolt 34, the rotary latch 44 reliably passes into one of its two end rotary positions and remains there. This action of the spring 54 on the rotary latch 44 is achieved by means of two flattened portions, which are arranged suitably in the circumferential direction, on the rotary latch shank against which the spring 54 bears in the fitted state (cf. also FIGS. 6 and 8).

FIG. 13 finally illustrates a modification of the means of securing the rotary position of the rotary latch 44 that has just been described. According to this modification, a second slider 18′ is provided with a latching contour 38′ and a snap-in receptacle 56′ for receiving a rotary latch of the type already described. However, in contrast to the embodiment illustrated in FIG. 12, a projection 54′, which is a fork-like design, of the second slider 18′, which is formed from plastic in this region, is additionally provided, the two “fork prongs” of which projection bear elastically against corresponding flattened portions on the shank of the fitted rotary latch and therefore take on the function of securing the rotary position.

### LIST OF REFERENCE NUMBERS

10 Adjustment device
12 Sliding roof cover
14 Guide rail
16 First slider (drive carriage)
18 Second slider
20 Deployment lever
22 Sliding piece
24 Slotted guide
26 Sliding piece
28 Slotted guide
30 Sliding piece
32 Guide channel (slotted guide)
34 Control bolt
36 Control slot
38 Latching contour
40 Guide rail web
42 Guide rail cutout
44 Rotary latch
46 First control cam
48 Second control cam
50 Latching cam
52 Guide rail surface
54 Spring
56 Snap-in receptacle

1. An adjustment device for a sliding roof cover on a vehicle, comprising a guide rail which runs in the a longitudinal direction, is mounted on the vehicle, and is intended for guiding first and second sliders which are arranged consecutively in the longitudinal direction and control the movement of the sliding roof cover,
wherein the first slider can be moved along the guide rail by a drive device and, over part of its movement range, carries along the second slider and, over another part of its movement range, leaves the second slider behind in a predetermined position along the guide rail,
wherein an arresting element which can be adjusted in height in a manner controlled by the first slider is arranged on the second slider and, when the second slider is left behind, is brought by a height adjustment into a form-fitting connection with a guide rail section in order to arrest the second slider on the guide rail,
wherein a rotary latch which can be rotated about a vertical axis in a manner controlled by the first slider is arranged on the second slider and, when the second slider is left behind, and after the height adjustment of the arresting element, is rotated into a rotary position locking the arresting action.

2. The adjustment device as claimed in claim 1, wherein the rotary latch has a radially protruding latching cam which, for locking purposes, pivots into a clearance, which is created by the height adjustment, between a section of the second slider, which section is connected to the arresting element, and a section of the guide rail.

3. The adjustment device as claimed in claim 1, wherein the rotary latch has two control cams which protrude radially, are offset in angle with respect to each other and with which a laterally protruding control bolt of the first slider interacts in order to rotate the rotary latch.

4. The adjustment device as claimed in claim 3, wherein the control bolt of the first slider interacts with a slotted guide track of a section of the second slider, which section is connected to the arresting element, in order to bring about the height adjustment.

5. The adjustment device as claimed in claim 1, wherein the rotary latch is secured in at least one of its locking rotary position at its unlocking rotary position by spring loading.

6. The adjustment device as claimed in claim 1, wherein, after the second slider is left behind, the first slider is completely decoupled from the second slider.

7. The adjustment device as claimed in claim 1, wherein the arresting element is arranged on an arresting lever, which can be pivoted about a transverse axis, of the second slider.

8. The adjustment device as claimed in claim 1, wherein the arresting element protrudes laterally from the second slider and, during the carrying-along of the second slider, runs in a guide channel of the guide rail, which guide channel is bounded by a horizontal guide rail web, and, when the predetermined position is reached, penetrates by means of the height adjustment into a cutout of the guide rail web.
